(19) United States
(12) Patent Application Publication
(10) Pub. No.: US 2011/0024461 A1
(43) Pub. Date: Feb. 3, 2011

(54) AERATION POURING DEVICE

(76) Inventors: Edward KILDUFF, New York, NY (US); Andrew Steever, Brooklyn, NY (US); Paul Goetz, Astoria, NY (US)

Correspondence Address: Pearl Cohen Zedek Latzer, LLP, 1500 Broadway, 12th Floor, New York, NY, 10036, US

(21) Appl. No.: 12/512,487

(22) Filed: Jul. 30, 2009

(51) Int. Cl. B67D 5/58; B01F 3/04; B67D 3/00

(52) U.S. Cl. 222/190; 99/323.1; 222/478

(57) ABSTRACT

The present invention generally relates to an aeration and pouring device adapted for positioning into a bottle. Specifically, the aeration and pouring device disclosed herein is adapted for aerating wine as it is poured directly from the wine bottle.

### BACKGROUND OF THE INVENTION

1. Field of the Invention

The present invention generally relates to an aeration and pouring device adapted for positioning into a bottle. Specifically, the aeration and pouring device disclosed herein is adapted for aerating wine as it is poured directly from its bottle. By inserting this device in the neck of a wine bottle, wine may be poured directly into a drinker's glass without the need of decanting. Thus, wine may be both poured and aerated in one step obviating the need for intermediate decanting and aeration.

2. Description of the Related Art

To most oenophiles, there is a need for aerating red wine prior to drinking. Such aeration allows the aromatics to more fully develop and to soften the tannins prior to drinking. To accomplish such aeration, wine is often poured from the bottle to a decanter prior to pouring into a drinker's glass. The use of a decanter, however, is arduous. A decanter is often expensive, fragile, and difficult to clean. Further, if the contents of the decanter are not fully consumed, the wine must be poured back into the bottle. Such pouring further aerates the wine which necessarily limits its drinking life.

To avoid the use of a decanter, a prior device has been suggested and is identified as a Vinturi™. However, this device is also independent of a wine bottle and must be held over a wine glass so that wine is poured from the bottle, through the Vinturi™, and into the wine glass. This device is believed to overaerate the wine because of the number of bubbles formed by its use. Wine enthusiasts have long counseled against overaeration and therefore dissuade shaking the wine bottle prior to pouring. This device is also difficult to control and often results in spilling some of the wine.

Another device that is used to aerate wine prior to drinking is SpinWine®. This device is adapted to fit into the neck of the wine bottle prior to pouring. However, this device has a number of drawbacks. For example, it requires the use of a helical member for aerating the wine which is difficult to clean and costly to manufacture. Further, it fails to allow a sufficient amount of air to enter the bottle thereby causing poor flow pouring characteristics. It is also provides insufficient aeration.

There is therefore a great need in the art for a device that is economical, easy to use, easy to clean, and one which allows for efficient pouring and aerating wine without the need for any intermediate element.

Accordingly, there is now provided with this invention an improved aeration and pouring device effectively overcoming the aforementioned difficulties and longstanding problems inherent in wine pouring and aeration. These problems have been solved in a simple, convenient, and highly effective way by which to insert a device directly into the neck of a wine bottle. More particularly, such a device aerates the wine and allows pouring directly into a user's wine glass so that the wine can be consumed to a degree sufficient for an oenophile's quality drinking criteria.

### SUMMARY OF THE INVENTION

According to one aspect of the invention, an aeration pouring device, is disclosed comprising a neck having a bore therethrough. A hollow tube, which is open at both ends, is positioned in a portion of the neck and extending outwardly therefrom. The device has a sealing element positioned about the neck, a hood extending from the neck, and a head attached to the neck and having a hole therein in fluid communication with the bore.

As will be appreciated by those persons skilled in the art, a major advantage provided by the present invention is that this device may be used to simultaneously pour and aerate wine directly from the wine bottle. Additional objects of the present invention will become apparent from the following description.

The method and apparatus of the present invention will be better understood by reference to the following detailed discussion of specific embodiments and the attached figures which illustrate and exemplify such embodiments.

### DESCRIPTION OF THE DRAWINGS

A specific embodiment of the present invention will be described with reference to the following drawings, wherein:

FIG. 1 is a cross-sectional side view of an embodiment of the present invention.

FIG. 2 is an exploded cross-sectional side view of the embodiment of FIG. 1.

FIG. 3 is an assembled side view of the embodiment of FIG. 1.

FIG. 4 is an orthogonal view of the embodiment of FIG. 1.

FIG. 5 is a side view side view of the embodiment of FIG. 1.

FIG. 6 is an orthogonal view of the underside of the embodiment of FIG. 1.

### DESCRIPTION OF THE PREFERRED EMBODIMENT

The following preferred embodiment as exemplified by the drawings is illustrative of the invention and is not intended to limit the invention as encompassed by the claims of this application. An apparatus for insertion into a bottle for pouring and aerating the fluid exiting therefrom is disclosed herein.

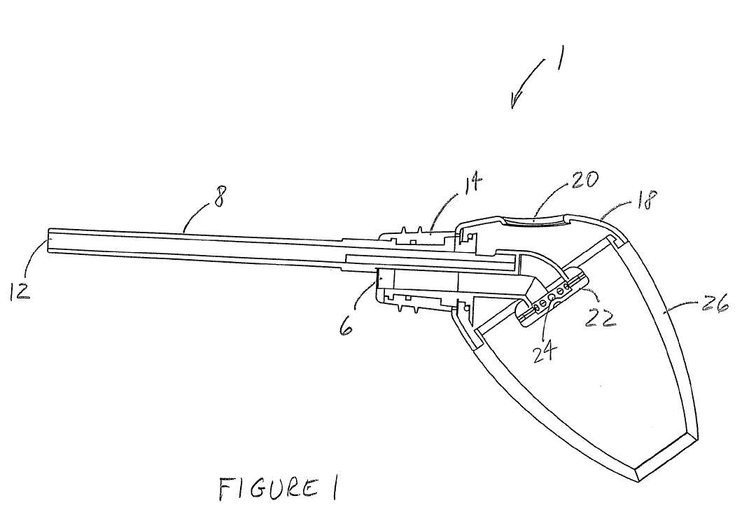

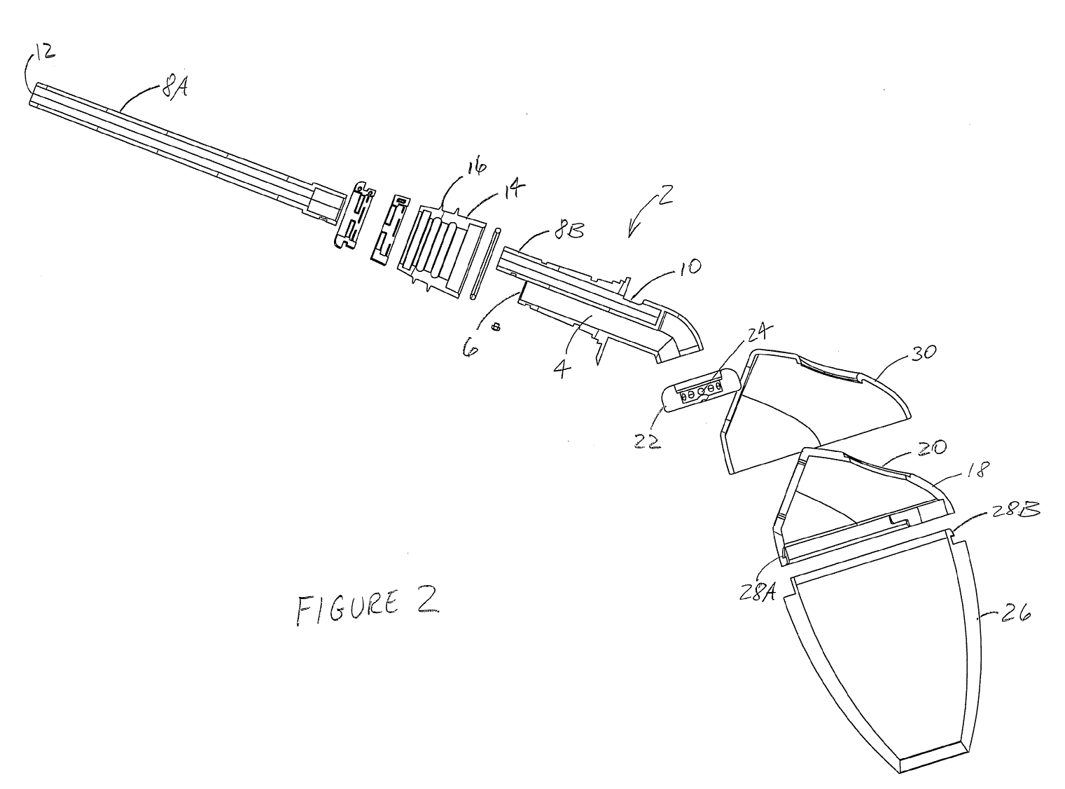

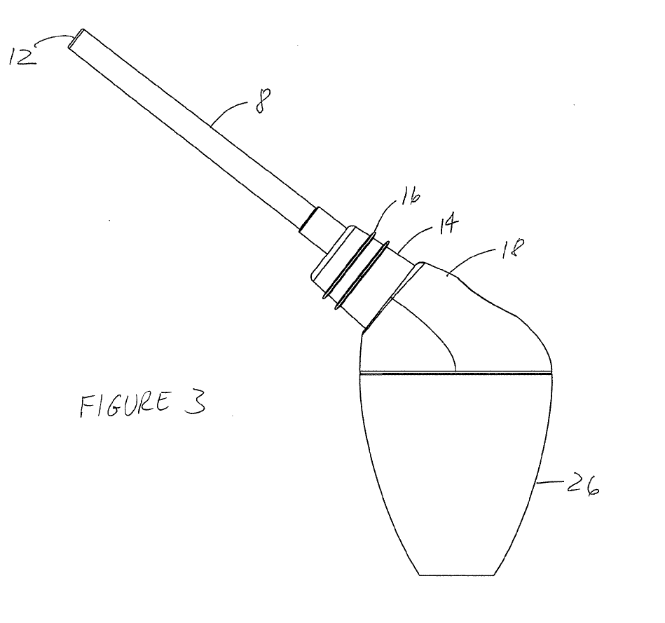

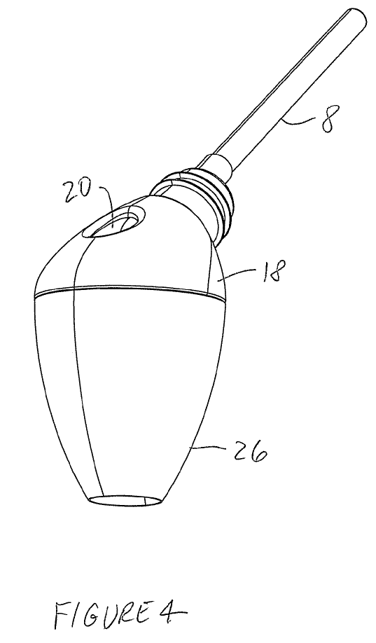

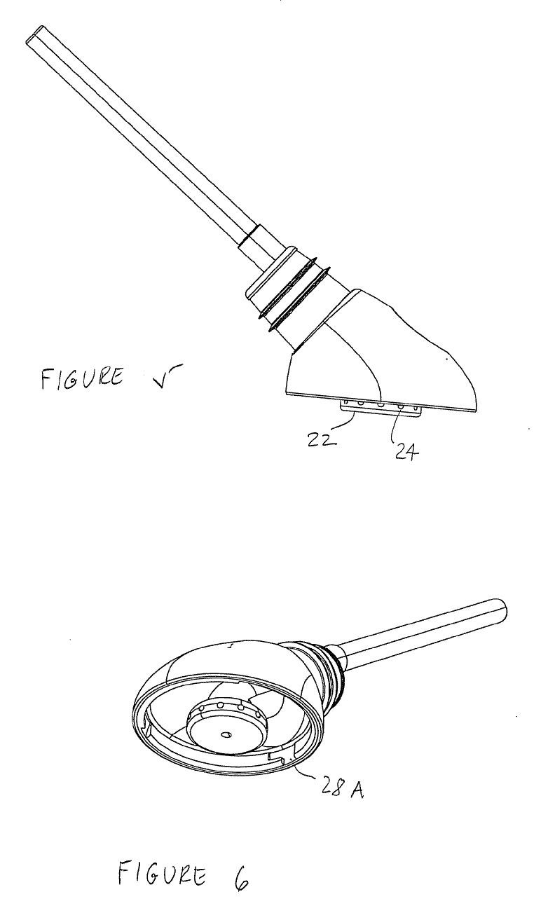

The device 1, is illustrated generally in FIGS. 1-4. The device has a neck 2 adapted for fitting into the neck of a bottle, preferentially, a wine bottle. The neck 2 has a bore 4 extending therethrough. The bore 4 has an opening 6 which allows the bottle contents to flow therein and through the bore itself. A hollow tube 8A is positioned on a hollow mating portion 8B extending from the neck. The mating portion 8B is positioned above the bore, preferably attached to an upper side wall of the neck, and thereby sharing a wall with the bore. For this reason, the shape of the bore is preferably crescent shaped. The hollow tube 8A when mated with the mating portion 8B forms a continuous sealed tube which has a proximate opening 10 and a distal opening 12. The continuous sealed tube is sealed from the bore.

A sealing element 14 is positioned about the neck for close fitting into the neck of a bottle. A rib 16 may be preferentially provided for increasing the sealing with the neck of the bottle. It may be further preferential to provide a plurality of ribs for sealing with the interior of a bottle's neck.

Attached to and extending from the neck 2 of the device is a hood 18. The hood 18 is provided with a hole 20 that is in fluid communication with the proximate opening 10 of the hollow tube 8. In this way, air may be directed into the bottle thereby displacing the liquid poured from the bottle to further aid in pouring. The hood hole 20 is preferably elliptical and preferably positioned toward the neck and away from the opening of the head to avoid wine spillage. A pouring head 22 is attached to the neck in fluid communication with the bore. The pouring head has at least one hole 24 and preferably a plurality of holes positioned therein. It may be further preferential to provide the plurality of head holes 24 peripherally about the pouring head.

A conical element 26 is detachably attached to the hood 20. The conical element has a mating portion 28B which mates with a corresponding mating portion 28A in the opening of the hood. The conical element may thus be detachably attached to the hood. Such mating attachment can be provided, for example, by means of a snap-fit, screw threads, or a twist-locking mechanism. It is preferable to have the conical element made of a clear material so as to ease guiding the pouring of the wine and for seeing the wine being aerated. The conical element may be made, for example, of an acrylic material.

For aesthetic purposes, it may be preferable to have the hood covered with a die-cast zinc cover 30. Such a cover would have a corresponding hole to align with the hood hole 20.

### EXAMPLE

It is to be understood that the following example of the present invention is not intended to restrict the present invention since many more modifications may be made within the scope of the claims without departing from the spirit thereof.

It has been found that the relationship between the length of the hollow tube, its inner diameter, and the size and number head holes through which the wine exits is important to achieve good fluid flow. In one embodiment, the length of the hollow tube is preferentially 8.3 cm and its inner diameter is preferentially 3.3 mm. In this embodiment, there are 12 head holes about the circumference of the head which each have a diameter of 1.5 mm. The size of the largest dimension of the crescent of the bore is preferably about 9.8 mm and the size of the smallest dimension of the crescent of the bore is preferably about 3.9 mm. The distance between the points of the crescent is about 8.0 mm. The major diameter of the elliptical hood hole is preferably 13.8 mm and the minor diameter is preferably 12 mm.

In use, the device described is inserted into the neck of a wine bottle after the cork has been removed and prior to pouring. Wine may then be poured directly into a drinker's glass through the inventive device. The wine flows into the bore and out of the holes in the pouring head. As it exits the head holes, it sprays against the inside of the conical element. It then flows out of the conical element into the wine glass. As the wine thus flows, it is aerated thereby improving its flavor and smell and avoiding the need for any additional or intervening step. As the wine flows into the bore, air passes into the hood through the hood hole, into the proximate opening of the hollow tube, through the hollow tube, and out of the distal opening into the bottle, thereby improving fluid flow characteristics.

Although the particular embodiments shown and described above will prove to be useful in many applications for pouring from a bottle and, in particular, the wine arts to which the present invention pertains, further modifications of the present invention will occur to persons skilled in the art. All such modifications are deemed to be within the scope and spirit of the present invention as defined by the appended claims.

What is claimed is:

1. An aeration pouring device, comprising:
a. a neck having a bore therethrough;
b. a hollow tube open at both ends, positioned in a portion of said neck and extending outwardly therefrom;
c. a sealing element positioned about said neck;
d. a hood extending from said neck; and
e. a head attached to said neck and having a hole therein in fluid communication with the bore.

2. The device of claim 1, having a hole through said hood.

3. The device of claim 1, wherein one end of said hollow tube opens into said hood and is sealed from said head.

4. The device of claim 1, having a plurality of head holes.

5. The device of claim 3, wherein said plurality of head holes are positioned circumferentially about said head.

6. The device of claim 5, wherein the diameter of each of said plurality of head holes is about 1.50 mm.

7. The device of claim 1, wherein said sealing element further comprises a rib extending therefrom for providing sealing in a neck of a bottle.

8. The device of claim 1, further comprising a conical element detachably connected to said hood.

9. The device of claim 8, wherein said conical element mates with said hood.

10. The device of claim 8, wherein said conical element threads into said hood.

11. The device of claim 8, wherein said conical element twist locks into said hood.

12. The device of claim 8, wherein said conical element snaps into said hood.

13. The device of claim 8, wherein said conical element is clear.

14. The device of claim 1, wherein said hollow tube has an inner diameter of about 3.6 mm.

15. The device of claim 1, wherein said hollow tube extends from said neck about 8.3 cm.

16. The device of claim 1, further comprising a die cast zinc cover positioned upon said hood.
